(19) United States
(12) Patent Application Publication
(10) Pub. No.: US 2026/0157272 A1
(43) Pub. Date: Jun. 11, 2026

(54) DEVICE FOR THE MAINTENANCE OF LAND, IN PARTICULAR FOR CUTTING GRASS

(71) Applicant: STIGA S.P.A. IN BREVE ANCHE ST. S.P.A., Castelfranco Veneto (IT)

(72) Inventors: Massimo Mazzocato, Maser (IT); Michele Volpato, Castello di Godego (IT)

(21) Appl. No.: 18/861,913

(22) PCT Filed: Apr. 14, 2023
(86) PCT No.: PCT/IB2023/053836

§ 371 Date: Oct. 31, 2024

(30) Foreign Application Priority Data
May 5, 2022 (IT) 102022000009278
May 5, 2022 (IT) 102022000009281

(51) Int. Cl. A01D 34/74; A01D 34/00; A01D 34/66; A01D 101/00

(52) U.S. Cl. CPC A01D 34/74; A01D 34/006; A01D 34/66; A01D 2101/00

(57) ABSTRACT

A device for the maintenance of land comprises a shell, a tool configured to execute maintenance operations on the land, a cutting deck carrying the tool and an adjustment system for adjusting the height of the cutting deck with respect to the shell. The adjustment system comprises at least one elastic element interposed between the cutting deck and the shell and configured to exert an elastic force on the cutting deck, the elastic force being suitable to produce a partial compensation of the weight force of the cutting deck. The adjustment system further comprises a control lever drivable by an operator and operatively connected to the cutting deck. The control lever is configured to move said cutting deck at least in height. Considering a dimension in width of said device, at least one gripping portion of the control lever is located centrally with respect to the dimension in width.

### FIELD OF THE INVENTION

The present invention relates to a mobile device aimed at carrying out land maintenance operations within a working area, for example mowing grass, or activities in the agricultural field. The present invention relates in particular to the movement of the cutting deck of said mobile device.

### STATE OF THE ART

It is known in the field of gardening and land maintenance to use mobile devices, such as lawnmower devices, having a vertically movable cutting deck so as to vary a cutting height of the turfgrass.

The cutting deck, according to the state of the art, can be moved vertically by acting on the wheels of the mobile device, thus causing a variation in height of the frame of the mobile device, and consequently a variation in height of the cutting deck.

Alternatively, the state of the art has mobile devices, such as lawnmower tractors, comprising a movable lever acting on the cutting deck, such that a movement of such a lever by an operator determines a simultaneous variation in height of the cutting deck.

U.S. Pat. No. 10,939,616B2 discloses a system employing a manual lever as the cutting deck lifting system. The lever has a very long length and is driven by the operator's feet. This type of solution is impractical to use since, during the lifting operation of the cutting deck, the entire weight of the deck is sustained by the operator.

US2021/0076566A1 discloses a pedal system as a lifting means of the cutting deck. One problem is the large number of components required to assemble this type of system.

EP2989880B1 discloses a manual system for lifting the cutting deck, with the use of a perforated plate and pins. This solution has a disadvantage from the operational point of view, represented by the fact that to change the cutting height the operator is forced to get down from the driving station and switch off the means to operate safely.

U.S. Pat. No. 11,006,574B1 discloses a system employing a knob, which thanks to a rotary movement allows to adjust the height of the cutting deck of the tractor. One disadvantage is the large number of components required to assemble this type of system.

U.S. 8,438,822B2 discloses a system for adjusting the height of the cutting deck, which employs a combination of a lever and a perforated plate with pins. This solution uses a lever in combination with a plate for fixing the cutting height; however, such a solution has a high construction complexity. It should also be noted that the operator must necessarily leave the driving station to adjust the height of the cutting deck.

The Applicant has further noted that the cutting deck of the mobile devices is often characterized by a high weight: the variation in height of the cutting deck can therefore be difficult and potentially burdensome for the operator.

Further known technical solutions are disclosed by US2007/0039304A1; U.S. Pat. No. 4,120,136; US2015/0359173A1; US2006/0179807A1; EP0518169A1.

### BRIEF DESCRIPTION OF THE DRAWINGS

Some embodiments of the invention will be described hereinafter with reference to the accompanying drawings, given merely for illustrative, non-limiting purposes in which:

FIG. 1 is a side view of a mobile device of the lawnmower tractor type in accordance with the present invention;

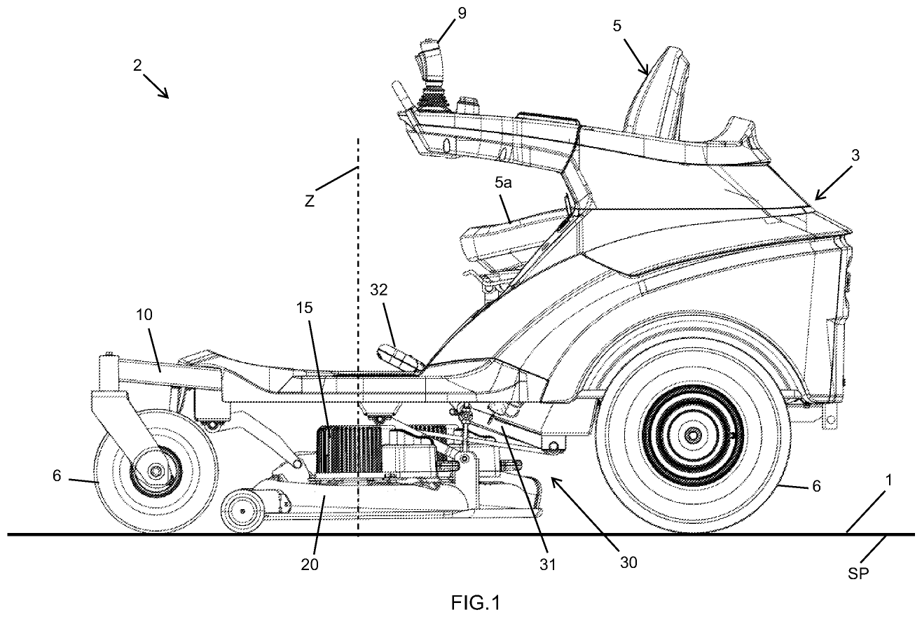

FIG. 2 is a top view of a mobile device of the lawnmower tractor type in accordance with the present invention;

FIG. 3 is a top view of the mobile device of FIG. 2 in which some components have been hidden;

FIG. 4 is a perspective view of a mobile device of the lawnmower tractor type in accordance with the present invention; FIGS. 4a and 4b are detailed enlargements related to FIG. 4;

FIG. 5 is a side view of a mobile device of the lawnmower tractor type in accordance with the present invention, in which the cutting deck adjustment system is highlighted;

FIGS. 6 and 7 are side views of a mobile device of the lawnmower tractor type in accordance with the present invention, respectively, in which the cutting deck is arranged in the lowered position and in the raised position;

FIG. 8 is an exploded view of the cutting deck height adjustment system.

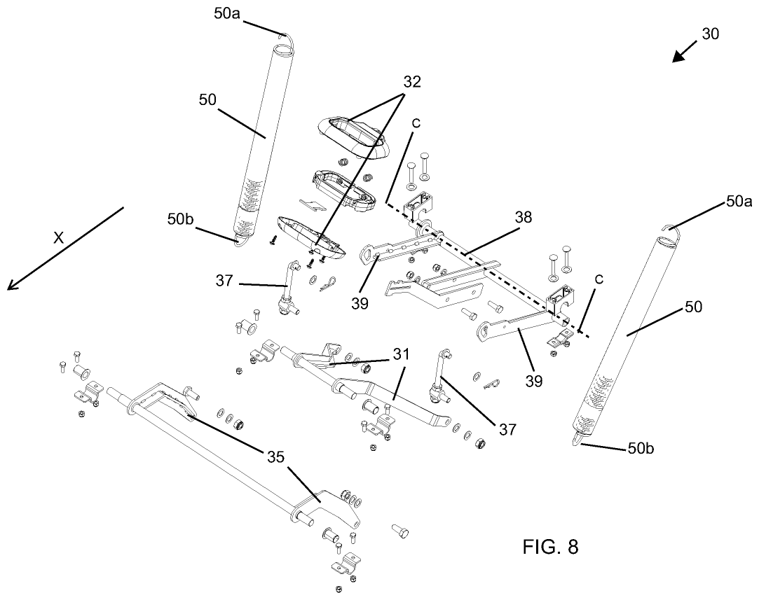

It should be noted that in the present detailed description, corresponding parts illustrated in the various figures are indicated with the same numerical references. The figures could illustrate the object of the invention through non—scale depictions; therefore, the parts and components illustrated in the figures related to the object of the invention could exclusively relate to schematic depictions.

### DETAILED DESCRIPTION

The present disclosure relates to a mobile device 2, also called device 2, configured to move and execute maintenance operations within a working area of land 1, such as turfgrass, a garden, or agricultural land, having an extension comprised between 10 and 20000 square meters, in particular between 500 and 10000 square meters: the maintenance operations can comprise, for example, cutting turfgrasses, soil aeration, soil tillage, sowing, and harvesting in a plantation or the like. In particular, the mobile device 2 can be, for example, a lawnmower as shown in the accompanying drawings.

The mobile device 2 can be a manually-driven device or a self-driving device.

The mobile device 2 can be a lawnmower tractor comprising a driving station 5 for receiving the operator on board, the latter adapted to drive the tractor inside the working area 1. In particular, the driving station 5 comprises a seat 5a adapted to supportingly receive the operator.

The lawnmower tractor further comprises at least one steering organ 9, for example a handlebar or a steering wheel or a joystick, operated by the driver and configured to steer the tractor in a desired direction. The lawnmower tractor 2 comprises driving movement means 6, for example one or more traction wheels, adapted to determine the advancement of the mobile device 2. An electric motor can be connected to the movement means 6 of the lawnmower tractor 2 to cause the movement: such a motor can have a nominal power comprised between 1.5 KW and 10 KW in the case of a tractor with a driving station for an operator. Alternatively, the lawnmower tractor can comprise an internal combustion engine operatively connected to driving movement means 6 to determine the movement thereof. The internal combustion engine can have a maximum power comprised between 3 KW and 200 kW.

The lawnmower tractor 2 preferably has a width comprised between 65 cm and 200 cm. Alternatively, the lawnmower tractor 2 can reach dimensions in length up to 6 metres: in this case the motor is preferably an internal combustion engine.

The lawnmower tractor 2 can comprise a rechargeable on-board battery having a charging capacity comprised between 5 Wh and 40 Wh and configured to electrically power the driving movement means 6. The battery can be configured to deliver a voltage preferably between 24 Volts and 48 Volts. In more detail, the battery can be configured to deliver a current, during a standard operating condition, between 2 Amperes and 20 Amperes. The battery can be a rechargeable battery via a power outlet of a home network, for example a 110V, 200V, 230V, 380V or 400V power source.

Alternatively, the mobile device 2 can be a manually-driven pushed lawnmower. In such a case the mobile device 2 can comprise an operating handle to allow the operator to move and guide the mobile device 2 within the working area 1. It should be noted that the mobile device 2 must have dimensions and mass consistent with the need to be pushed by the user inside the working area 1. The pushed lawnmower does not comprise a driving station for the operator.

The pushed lawnmower can comprise driving or idle movement means 6. If the movement means 6 are driving, the mobile device 2 can comprise one or more electric motors optionally connected to an on-board controller and to at least one drive wheel of the mobile device 2 to determine the advancement movement thereof. The electric motor of the driving movement means 6 of the pushed lawnmower 2c can have a nominal power comprised between 500 W and 2000 W, in particular between 1300 W and 1500 W.

The pushed lawnmower can comprise a rechargeable on-board battery having a charging capacity comprised between 2.5 Wh and 40 Wh and configured to electrically power the driving movement means. The battery can be configured to deliver a voltage preferably between 24 Volts and 48 Volts. In more detail, the battery can be configured to deliver a current, during a standard operating condition, between 2 Amperes and 5 Amperes. The battery can be a rechargeable battery via a power outlet of a home network, for example a 110V, 200V, 230V, 380V or 400V power source.

The mobile device 2, in accordance with each of the above-described embodiments, i.e., in accordance with the lawnmower tractor and the pushed lawnmower, comprises at least one tool 4, for example a work tool configured to execute maintenance operations in the working area 1. In particular, the tool 4 can comprise a cutting element movable by rotation about a rotation axis A: the tool 4 is adapted to allow, for example, mowing the turfgrass. The tool 4 can comprise a single rotating blade, or a plurality of rotating blades.

The mobile device 2 of the present invention comprises a support frame carrying the movement means 6, whether driving or idle, and one or more tools 4, for example one or two cutting blades, configured to execute maintenance operations within the working area 1. In detail, the movement means 6 can comprise wheels, in particular two, three or four wheels, or tracks. The wheels can be arranged at respective four vertices of a support frame 3 of the mobile device 2, defining a rectangular or square polygonal shape.

The mobile device 2 extends in length between the front portion and the rear portion, defining a longitudinal axis X of the mobile device 2. In particular, the longitudinal axis X of the mobile device 2 crosses the front portion and the rear portion in a substantially orthogonal manner. In greater detail, the longitudinal axis X of the mobile device 2 can define an axis of symmetry between the left side and the right side of the mobile device 2 and pass through a central portion of the mobile device 2 itself. Similarly, a straight advancement of the mobile device 2 can be coincident with the longitudinal axis X of the mobile device 2. Furthermore, the longitudinal axis X can be substantially orthogonal to the front and/or rear wheel axis of the mobile device 2. Furthermore, the longitudinal axis X can be equidistant from the left and right wheels of the same axis: in such a case the longitudinal axis X defines a central longitudinal axis of the mobile device 2. In particular the longitudinal axis X, in the present description, is considered placed centrally in the mobile device 2.

The movement means 6 define a support plane SP for the mobile device 2: in fact, such a support plane SP is coincident with the land during an operating condition of the mobile device 2. In more detail, the support plane SP is through the contact points between the wheels of the mobile device 2 and the land 1 on which the mobile device 2 is arranged.

The movement means 6 can also define a straight advancement of the mobile device 2 along a longitudinal advancement direction which is substantially coincident with the longitudinal axis X of the mobile device 2: in particular, the longitudinal advancement direction is substantially orthogonal to a rotation axis of the wheels of the mobile device 2. Such a longitudinal advancement direction is substantially parallel to the support plane SP. Similarly, the longitudinal axis X is parallel to the support plane SP.

If the mobile device 2 is a lawnmower and comprises a rotating blade 4a, such a rotating blade is movable about a rotation axis A which is transverse or substantially orthogonal to the support plane SP. In particular, this rotation axis A can be transverse, optionally orthogonal, to the longitudinal axis X. In particular, such a rotation axis A can intersect the longitudinal axis X. Such a rotation axis A can be substantially orthogonal to the land 1.

The mobile device 2 also extends in height along a vertical axis Z orthogonal to the longitudinal axis X and to the support plane SP. In other words, the vertical axis X is orthogonal, when the mobile device 2 is resting on the land on its own movement means 6, to the land itself.

Furthermore, the mobile device 2 extends in width along a transverse axis W between a left side, interposed in connection between the front portion and the rear portion of the mobile device 2, and a right side, also interposed in connection between the front portion and the rear portion of the mobile device 2; the right side is opposite and spaced with respect to the left side. In particular, the transverse axis W is orthogonal to the longitudinal axis X and to the vertical axis Z. The axis of the front wheels and/or rear wheels is parallel to the transverse axis W and optionally substantially parallel to the support plane SP.

The transverse axis W and the longitudinal axis X together define a plane substantially parallel to the land 1 when the mobile device is supported on the ground.

Thus, the longitudinal axis X, the transverse axis W and the vertical axis Z define a reference system of the mobile device 2. The origin of the reference system can be the mass or geometric centre of gravity of the mobile device 2.

In accordance with such a reference system, the rotation axis A of the rotating blade is substantially parallel or coincident with the vertical axis Z of the mobile device 2.

The mobile device 2 comprises a shell 3, made of one among a plastic, composite, and metal material or a combination thereof, and carrying the electric motor 10 of the tool. The shell 3 can further define, in part or in full, the frame of the mobile device. The shell 3 can further carry the movement means 6, for example the wheels of the robot lawnmower, or of the pushed lawnmower. The shell 3 can further carry the on-board battery and optionally the on-board controller.

The mobile device 2 comprises a cutting deck 20 which is movable in height substantially along the vertical axis Z, between a raised position and a lowered position with respect to the support plane SP. In particular, during an operating condition, the operating unit can be movable in height along the vertical axis Z between a raised position and a lowered position with respect to the land, to allow a variation in the cutting height of the turfgrass. A change along the vertical axis Z of the cutting deck causes a simultaneous change in height of the tool 4, and consequently a change in the distance between the tool 4 and the land and/or the support plane.

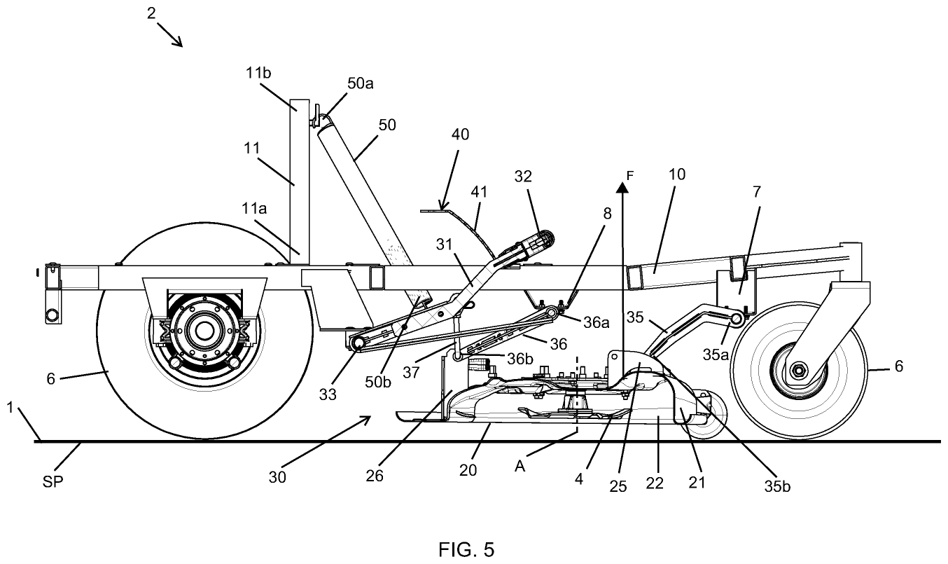

The cutting deck 20 of the mobile device 2 comprises an outer cap 21 internally defining a cavity 22, as shown in the sectional view of FIG. 5. In particular, the cap 21 can have a curved and/or concave shape, having side walls extending in height along the vertical axis Z and a top wall connected to the side walls, to internally define the cavity 22. A surface inside the cap 21 and delimiting the cavity therefore has a concave shape, intended, during a condition of use of the mobile device 2, to be facing the land 1. The side walls of the cap 21 define a peripheral portion of the cap 21.

The cavity 22 is primarily intended to house the tool 4, i.e., one or more cutting elements 4a rotating inside the cavity 22; the cap 21 is consequently intended to enclose the tool 4 therein, so as to protect an operator from contact with the cutting elements and to avoid the lateral exit of stones, grass, or the like which can injure or strike, for example, the operator or other subjects. The cap 21 can furthermore be intended to convey the cut grass towards an expulsion channel extending between the cap 21 and an outlet section. Such an outlet section can be a free outlet, i.e., where the cut grass exits from the expulsion channel without being collected.

Alternatively, the mobile device 2 can comprise a collection bag connected or configured to be connected to the outlet section of the expulsion channel so as to collect the cut grass. The collection bag can be used in association with the lawnmower and the pushed lawnmower.

The cap 21 is made from one among a plastic, composite, and metal material or a combination thereof. Optionally the cap 21 can be made of aluminium.

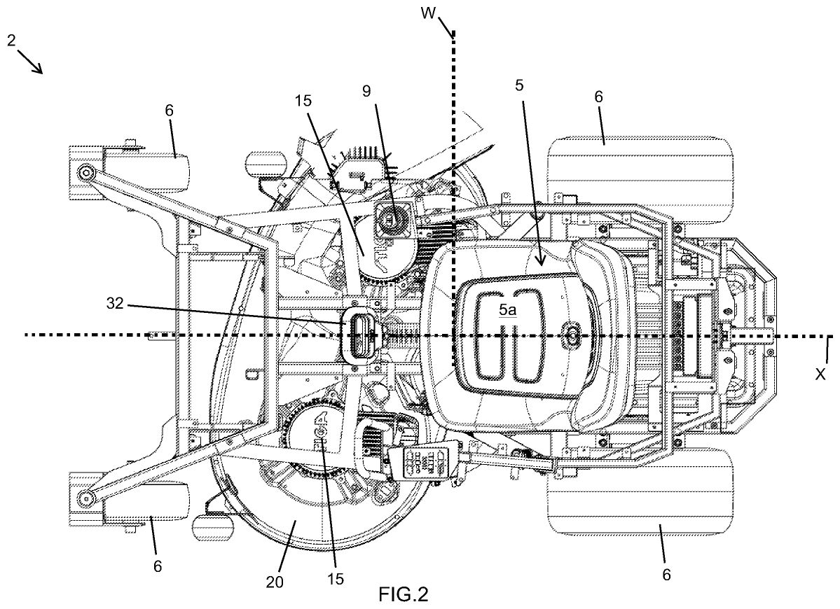

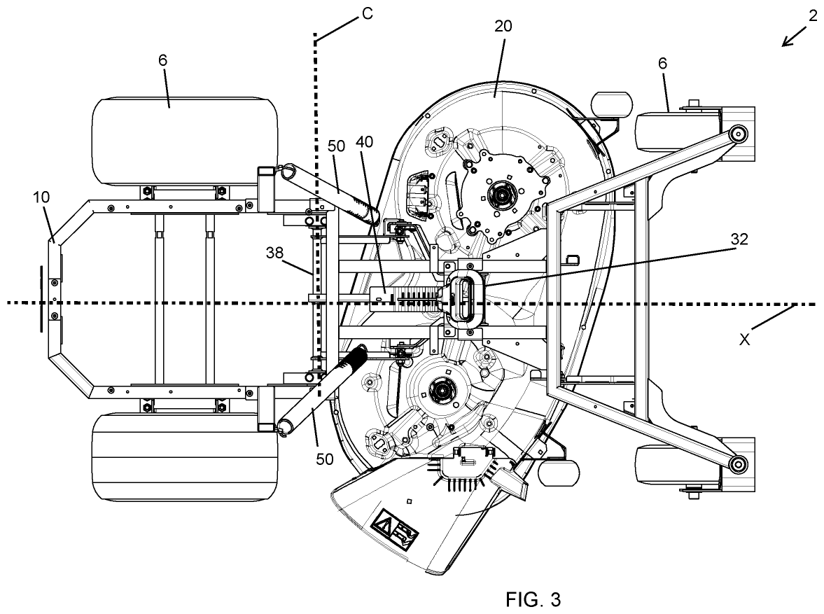

The cutting deck 20 can be defined as “single”, i.e., in which the cutting deck comprises a single cap 21 housing one and only one tool 4. Alternatively, as shown in the embodiments of FIGS. 2-4, the cutting deck 20 can be “double”, i.e., in which the cutting deck comprises two caps 21 side by side, in which each cap houses a respective tool 4, so that, in such an embodiment, the cutting deck 20 carries two tools 4, for example two rotating blades side by side. It should be noted that this embodiment comprising two tools is advantageously associated with the lawnmower tractor, but can also be applied to the lawnmower. The rotation axes of each tool 4 are side-by-side and staggered with each other in width so as to increase the dimension in width of the cutting deck. This allows the cutting extension to be increased in width during a condition of use of the mobile device. Having described in detail a double cutting deck 20, it is intended to point out how, according to the present invention, the cutting deck can more generally be “multiple”, i.e., it can accommodate tools 4 for cutting grass in a number equal to two or three or four or five or six or seven or eight or nine or ten or in a number greater than ten, said tools being rotatable with respect to respective rotation axes substantially parallel to each other. In the case of a double or multiple cutting deck, the tools can be synchronised with each other, so as to avoid possible collisions during operation. If the tools are instead not synchronised with each other, at least two of the tools are staggered along the longitudinal axis X of the mobile device 2, i.e., along the advancement direction of the mobile device 2.

In an embodiment, the cap 21 of the cutting deck 2 carries a drive motor 15 connected to the tool 4 and configured to cause the rotation thereof about the rotation axis A. The drive motor 15 can be supported and constrained above the cap 21, such that the cap is interposed, along the vertical axis Z, between the land 1 and the drive motor 15. The drive motor can thus weigh directly on the cutting deck 20. In particular, the cutting deck 20 and the drive motor 15 can be integral with each other, such that a movement in height of the cutting deck 20 can correspond to a respective, in particular equal, movement in height of the drive motor 15.

The drive motor can be connected directly, or by means of a transmission system, to the tool 4. The drive motor comprises a rotation shaft rotatable about a substantially vertical working axis B, in particular parallel or coincident with the vertical axis Z of the mobile device. In particular, the working axis B of the drive motor can be parallel or coincident with the rotation axis A of the tool 4. The rotation of the rotation shaft of the drive motor causes the simultaneous rotation of the tool 4.

The drive motor 15 can comprise an electric motor, for example of the brushless type, or a combustion engine, for example an Otto or Diesel cycle motor. The electric drive motor 15 can be powered by means of a home network through an electric cable, or the device can carry a rechargeable battery connected in power supply to the drive motor 15.

The mobile device 2 comprises an adjustment system 30 adapted to move the cutting deck 20 in height. The adjustment system 30 is thus configured to vary the distance between the tool 4 and the land 1: in particular the adjustment system 30 is configured to vary the distance between the tool 4 and the support plane SP. A variation of the position in height of the cutting deck 20 allows to vary the cutting height of the turfgrass during the steps of mowing the grass. The adjustment system 30 thus causes a movement of the cutting deck 20 and the tool 4 with respect to the shell 3 of the device 2. The adjustment system 30 can cause a movement of the cutting deck 20 in height, i.e., from the bottom to the top and vice versa along the vertical axis Z. In particular, the adjustment system 30 can cause a movement of the cutting deck 20 in height and, at the same time, a movement of the cutting deck 20 along the longitudinal axis X or along the transverse axis W of the device 2. In other words, the adjustment system 30 can cause, in addition to the variation in height of the cutting deck, also a lateral or longitudinal movement of the cutting deck 20. Alternatively, in an embodiment not shown in the accompanying drawings, the adjustment system 30 can be configured to cause only a vertical movement of the cutting deck along the vertical axis Z, without thereby causing lateral or longitudinal movements of the cutting deck 20.

It should be noted that the cutting deck 20 and the tool 4 are integral with each other in the lateral, longitudinal and vertical movement: consequently, a displacement in height or lateral or longitudinal displacement of the cutting deck 20 corresponds to the same displacement of the tool 4. The tool 4 is movable with respect to the cutting deck only for a rotational degree of freedom around the rotation axis A.

The adjustment system 30 of the present invention is applicable both to “single” cutting plates 20, i.e., provided with a single tool, and to “double” or “multiple” cutting plates 20, i.e., provided with two or more tools 4, as described above.

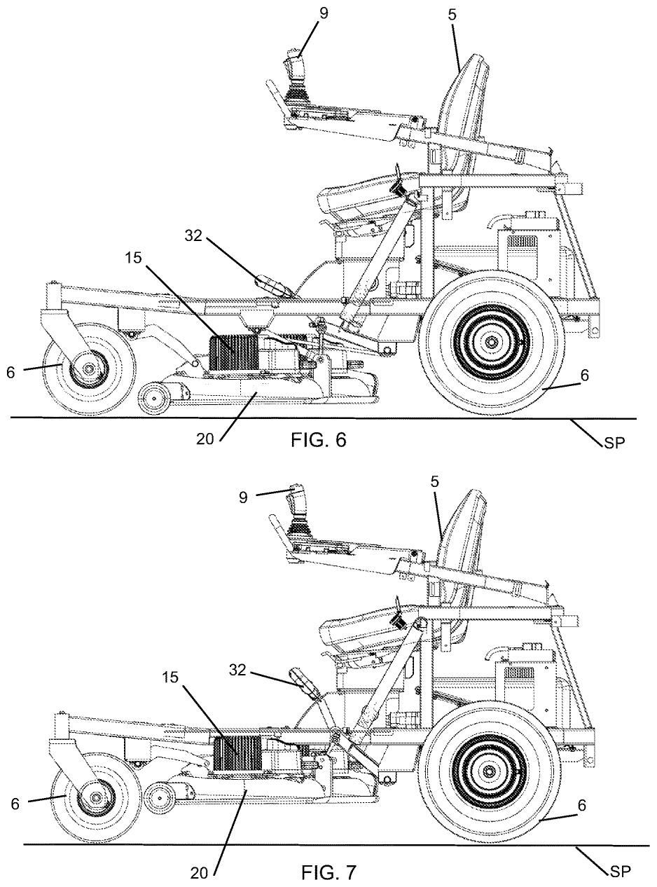

The adjustment system 30 is configured to move the cutting deck 20 in height with respect to the land 1, in particular with respect to the support plane SP, between a lowered position, shown in FIG. 6, and a raised position, shown in FIG. 7. In the lowered position, a first distance is interposed between the tool 4 and the land 1 during an operating condition of the device 2. In particular in the lowered position, a first distance is interposed between the tool 4 and the support plane SP. In the raised position, a second distance is interposed between the tool 4 and the land 1 during an operating condition of the device 2. In particular in the raised position, a second distance is interposed between the tool 4 and the support plane SP. The second distance is greater than the first distance: in other words, the cutting deck 20, when arranged in the raised position, has a distance with respect to the land 1 or to the support plane SP which is greater with respect to the distance when arranged in the lowered position. Consequently, when the cutting deck is arranged in the raised position, the turfgrass will be mowed at a higher height with respect to the case in which the cutting deck is arranged in the lowered position.

An operator can choose whether to arrange the cutting deck in the raised position or in the lowered position: for example, the operator can choose to raise the cutting deck 20 if the turfgrass to be mowed is particularly high. On the contrary, the operator can choose to lower the cutting deck 20 if he wishes to obtain a particularly low lawn. Alternatively, the operator can choose between the raised position and the lowered position as a function of the conditions of the turfgrass, for example if the turfgrass is wet or dry.

In a preferential embodiment, of the type shown in the accompanying drawings, the adjustment system 30 is configured to keep the tool 4 and/or the cutting deck 20 substantially parallel to the land, in particular to the support plane SP, during a movement in height of the cutting deck. Thereby, the variation of the position of the cutting deck between the raised and lowered position does not adversely affect the quality of the cut.

The lowered position can define a minimum position in height, while the raised position can define a maximum position in height of the cutting deck: in other words, the difference between the lowered position and the raised position defines the maximum stroke of the cutting deck in height.

It should be noted that the cutting deck 20 can be arranged at intermediate positions in height between the lowered position and the raised position. For example, the adjustment system 30 can be configured to arrange the cutting deck at one of two or more intermediate positions in height interposed between the raised position and the lowered position.

The device 2 comprises at least one movable control lever 31 operable by an operator and operatively connected to the cutting deck 20: the control lever 31 is configured to move the cutting deck 20 in height. A movement of the control lever 31, by the operator, simultaneously causes a movement in height of the cutting deck 20. As previously discussed, a movement of the control lever 31 can cause, in addition to the movement in height of the cutting deck 20, also a lateral or longitudinal displacement of the cutting deck.

It should be noted that the adjustment system 30 of the cutting deck 20 is a manual adjustment system, in particular without electric, pneumatic or hydraulic actuators. In particular, the adjustment system 30 comprises a kinematic chain of arms which transfers the movement of the control lever 31, actuated by the operator, to the cutting deck 20. In other words, the adjustment system 30 is a purely mechanical adjustment system.

The control lever 31 is movable between a first position defining the lowered position of the cutting deck 20, and a second position defining the raised position of the cutting deck 20. Furthermore, the control lever 31 can comprise intermediate positions interposed between the first position and the second position, in which each of the intermediate positions of the control lever 31 defines a respective intermediate position of the cutting deck 20 interposed between the lowered position and the raised position. The control lever 31 can be movable between the first position and the second position by translation, rotation or rototranslation. In accordance with the embodiment shown in the accompanying drawings, the control lever 31 is movable by rotation about a fulcrum 33.

The control lever 31 comprises a gripping portion 32 configured to be gripped by an operator, so as to move the control lever 31 between the first and the second position. The gripping portion 32 defines an end of the control lever 31. The gripping portion 32 can have the form of a knob or a bar or be handle-like.

The gripping portion 32 of the control lever 31 is movable towards and away from the driving station 5. In particular, the first position of the control lever 31 defines a distal position between the gripping portion 32 of the control lever and the driving station 5, while the second position of the control lever 31 defines a close position between the gripping portion 32 of the control lever 31 and the driving station 5. It should be noted that the close position defines a distance between the gripping portion 32 of the control lever and the driving station 5 which is less than a distance between the gripping portion 32 of the control lever and the driving station 5 when the control lever is in the distal position. In other words, the gripping portion 32 of the control lever 31 is closer to the driving station 5 when the control lever 31 is arranged in the close position.

Optionally, a maximum distance between the driving station 5 and the gripping portion 32 of the control lever 31 is comprised between 10 cm and 30 cm, more in particular between 11 cm and 27 cm.

The control lever 31 can be arranged centrally before, and in particular in front of, the driving station 5. The gripping portion 32 of the control lever 31 can thus be arranged, during an operating condition of the device 2, between the legs of the operator sitting on the driving station 5. In particular, the control lever 31 is longitudinally interposed between a front area of the mobile device and the driving station 5.

In greater detail, an axis through the control lever 31 and the driving station 5, in particular for a central portion of the driving station 5, is substantially parallel or coincident with the longitudinal axis X of the device 2. Similarly, the control lever 31 is substantially equidistant from the left side and from the right side of the device 2.

In greater detail, as evident from the top view of FIG. 2, the driving station 5 extends in width, for example parallel to the transverse axis W, between a right side thereof and a left side thereof: the control lever 31 is placed in front of the driving station and interposed between an axis through the right side of the driving station and an axis through the left side of the driving station 5.

The control lever can be placed at a height, with respect to the vertical axis Z, which is lower with respect to a height of the seat of the driving station 5: for example the control lever 31 can be placed at an intermediate height between the seat 5a of the driving station 5 and the cutting deck 31.

The control lever 31 further comprises a fulcrum 33 configured to constrain the control lever to the shell 3 of the device 2. The fulcrum 33 can define a connection hinge between the control lever 31 and the shell 3 of the device, such that the control lever is movable by rotation about a rotation axis C defined by such a fulcrum 33.

The fulcrum can define an end of the control lever 31 opposite the gripping portion 32. In other words, the control lever 31 can extend in length between the gripping portion 32 and the fulcrum 33. In particular, the control lever 31 can extend in length between 25 cm and 50 cm. In greater detail, the distance between the fulcrum 33 and the gripping portion is comprised between 35 cm and 40 cm. The rotation axis C of the fulcrum 33 of the control lever 31 is preferably transverse or substantially orthogonal to the longitudinal axis X of the device 2. Furthermore, the rotation axis C of the control lever 31 can be substantially parallel to the transverse axis W of the device 2. In greater detail, the rotation axis C of the control lever 31 is substantially parallel to the support plane SP.

The fulcrum 33 of the control lever 31 is fixed, in particular fixed with respect to the shell of the device 2, during a movement of the control lever 31. Consequently, also the rotation axis C of the fulcrum 33 is fixed in position with respect to the shell 3.

A first displacement of the gripping portion 32 of the control lever 31 corresponds to a second displacement in height, along the vertical axis Z substantially orthogonal to the land 1 and/or to the support plane SP, of the cutting deck 20. It should be noted that the second displacement of the cutting deck 20 is less than the first displacement of the gripping portion 32: in particular a ratio between the second displacement and the first displacement can be comprised between 0.3 and 0.8. Such a ratio between the first displacement and the second displacement defines the lever ratio of the adjustment system 30 of the device 2. Since such a ratio is less than 1, the adjustment system is configured to reduce the force to be applied to the gripping portion 32 necessary to move the cutting deck 20 in height from the lowered position to the raised position.

The control lever 31 can comprise, in an embodiment not shown in the accompanying drawings, a connecting portion interposed between the fulcrum 33 and the gripping portion 32: the connecting portion can be intended to connect the control lever 31 to the cutting deck 20 or to one or more arms connected to the cutting deck 20. In fact, the connecting portion of the control lever defines a kinematic constraint between the control lever 31 and the cutting deck 20 or one or more arms connected to the cutting deck 20. It should be noted that the control lever 31, in combination with the fulcrum 33 and the connecting portion, defines a second type of lever.

The embodiment shown in the accompanying drawings provides an adjustment system 30 comprising articulated quadrilateral kinematics, in which at least a first oscillating arm and a second oscillating arm connect the cutting deck 20 to the shell 3. The articulated quadrilateral is shown in detail in the side view of FIG. 5.

In particular, the adjustment system 30 comprises the cutting deck 20 having a first coupling 25 and a second coupling 26 spaced apart from each other. The distance interposed between the first coupling 25 and the second coupling 26 of the cutting deck 20 can be comprised between 25 cm and 50 cm. The first coupling 25 can be substantially equal in height to that of the second coupling 26. In particular, an axis through the first coupling 25 and the second coupling 26 of the cutting deck 20 is substantially parallel to the support plane SP defined by the movement means 6 of the device 2.

The first coupling 25 is placed in an advanced area with respect to the second coupling 26: in other words, a distance between a front axis of the mobile device 2 and the first coupling 25 is smaller than a distance interposed between the same front axis of the mobile device 2 and the second coupling 26. The adjustment system 30 further includes a portion of the shell 3 comprising a first support 7 and a second support 8 spaced apart from each other. The distance interposed between the first support 7 and the second support 8 of the shell 3 can be comprised between 30 cm and 45 cm.

The first support 7 can be substantially at a height substantially equal to that of the second support 8. In particular, an axis through the first support 7 and the second support 8 of the shell 3 can be substantially parallel to the support plane SP defined by the movement means 6 of the device 2.

The first support 7 is placed in an advanced area with respect to the second support 8: in other words, a distance between a front axis of the mobile device 2 and the first support 7 is smaller than a distance interposed between the same front axis of the mobile device 2 and the second support 8.

In a preferred embodiment, the distance interposed between the first coupling 25 and the second coupling 26 of the cutting deck 20 can be substantially equal to the distance interposed between the first support 7 and the second support 8 of the shell 3.

The adjustment system 30 further comprises a first oscillating arm 35 placed in connection between the cutting deck 20 and the shell 3. In particular the first arm 35 connects the first support 7 of the shell to the first coupling 25 of the cutting deck. More in detail, the first arm 35 extends between a first connector 35a constrained to the first support 7 of the shell 3, and a second connector 35b constrained to the first coupling 25 of the cutting deck 20. A distance interposed between the first connector 35a and the second connector 35b of the first arm 35 can be comprised between 18 cm and 30 cm. The first arm 35 can be made of metallic material, for example aluminium or steel, or of plastic or composite material.

The adjustment system 30 further comprises a second oscillating arm 36 placed in connection between the cutting deck 20 and the shell 3. In particular, the second arm 36 connects the second support 8 of the shell to the second coupling 26 of the cutting deck 20. In greater detail, the second oscillating arm 36 extends between a first connector 36a, constrained to the second support 8 of the shell 3, and a second connector 36b constrained to the second coupling 26 of the cutting deck 20. A distance interposed between the first connector 36a and the second connector 36b of the second arm 36 can be comprised between 18 cm and 30 cm. The second arm 36 can be made of metallic material, for example aluminium or steel, or of plastic or composite material.

In an embodiment, the distance between the first connector 35a and the second connector 35b of the first arm 35 can be substantially the same as the distance between the first connector 36a and the second connector 36b of the second arm 36.

In an embodiment shown in FIG. 5, the adjustment system 30 comprises a return bar 38 extending in length along the rotation axis C of the fulcrum 33 of the control lever 31, and in which such a return bar 38 is integral, at least in rotation, with the control lever 31. In particular, the return bar 38 can be welded to the control lever 31 to define a single body. In fact, therefore, the control lever 31 comprises the return bar 38.

The return bar 38 can be substantially orthogonal to the extension in length of the control lever 31. The return bar 38 can be made of metallic material such as aluminium or steel, alternatively the return bar 38 can be made of composite plastic material. If both the return bar 38 and the control lever are made of metallic material, the return bar 38 can be welded to the control lever 31 at the fulcrum 33. The return bar 38 can extend from both sides of the control lever 31: for example the return bar 38 can extend from the control lever 31 towards a left side of the device 2, and from the control lever towards a right side of the device 2.

The adjustment system 30 can further comprise a drive lever 39 constrained to the return bar 38, such that the return bar 38 is operatively interposed between the drive lever 39 and the control lever 31. The drive lever 39 is transverse or substantially orthogonal to the return bar 38. For example, the drive lever 39 can be parallel to the control lever 31. In fact, the drive lever 39 extends in length between a first end 39a constrained to the return bar 38 and a second end 39b. The first end 39a of the drive lever can be welded or bolted to the return bar 38, so that the return bar 38 and the drive lever 39 define a single body. In particular, in an embodiment of the type shown in the accompanying drawings, the control lever 31, the return bar 38 and the drive lever 39 define a single body. In fact, therefore, the control lever comprises the return bar 38 and the drive lever 39.

The second end 39b of the drive lever 39 is connected, directly or indirectly, to the cutting deck 20, for transferring the movement of the control lever to the cutting deck. In an embodiment not shown in the accompanying drawings, the second end 39b of the drive lever 39 can be connected directly to the cutting deck 20, for example to the first coupling 25 or to the second coupling 26 or to a third coupling of the cutting deck 20.

Alternatively, as shown in FIG. 5, the adjustment system 30 comprises a connecting rod 37 operatively interposed between the cutting deck 20 and the control lever 31, so as to transmit a displacement imposed on the control lever 31 to the cutting deck 20. In particular, the connecting rod 37 defines a direct or indirect connection between the control lever 31 and the cutting deck 20. In greater detail, the connecting rod 37 is configured to transfer the rotational movement of the control lever 31 to the cutting deck 20, so as to cause the movement of the cutting deck 20 between the lowered position and the raised position and vice versa.

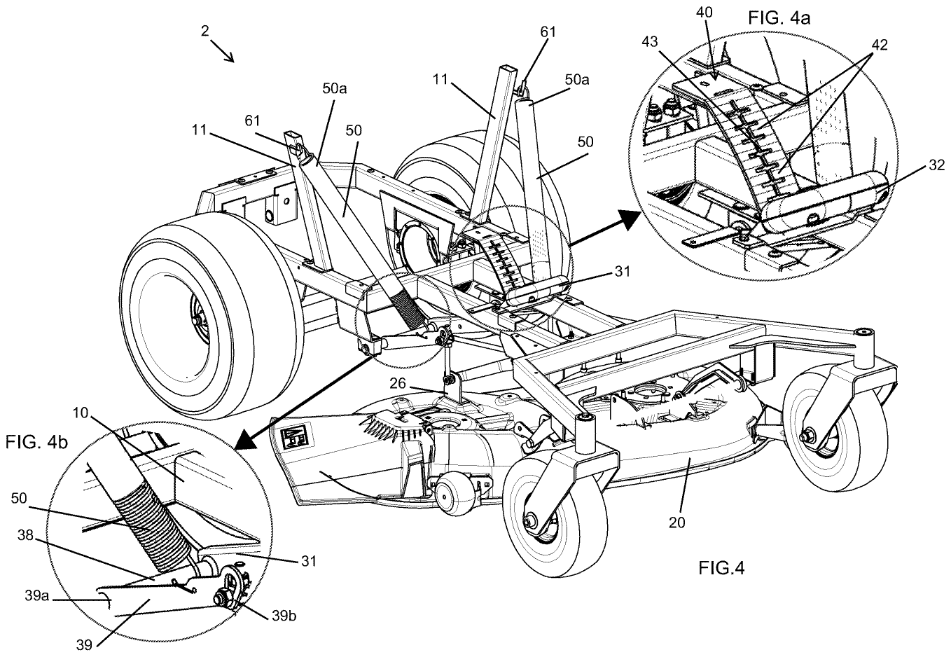

In a specific embodiment shown in FIGS. 4 and 5, the connecting rod 37 is placed in connection between the second end 39b of the drive lever 39 and the second coupling 26 of the cutting deck 20. Alternatively, the connecting rod 37 can be placed in connection between the second end 39b of the drive lever 39 and the first coupling 25 of the cutting deck 20. Alternatively, the connecting rod 37 can be placed in connection between the second end 39b of the drive lever 39 and a third coupling of the cutting deck. Alternatively, the connecting rod 37 can be placed in connection between the second end 39b of the drive lever 39 and a portion of the first arm 35 and/or the second arm 36.

In an embodiment not comprising the return bar 38, the connecting rod 37 can be placed in connection between the connecting portion of the control lever 31 and the second coupling 26 of the cutting deck 20. Alternatively, the connecting rod 37 can be placed in connected between the connecting portion of the control lever 31 and the first coupling 25 of the cutting deck 20. Alternatively, the connecting rod 37 can be placed in connection between the connecting portion of the control lever 31 and a third coupling of the cutting deck 20 which is distinct and spaced from the first coupling 25 and the second coupling 26. Alternatively, the connecting rod 37 can be placed in connection between the connecting portion of the control lever 31 and a portion of the first arm 35 and/or the second arm 36.

The adjustment system 30 can further comprise a locking system 40 configured to hold the cutting deck 20 in a height position preselected by the operator. For example, the locking system 40 can be configured to lock the cutting deck 20 in the raised position, the lowered position, or one or more intermediate positions between the lowered position and the raised position. The locking system can be acting on the control lever 31 and/or on the cutting deck 20.

In the embodiment shown in FIG. 4, and in detail in FIG. 4a, the locking system 40 is acting on the control lever 31. The locking system 40 can comprise a plate 41 having one or more teeth 42 configured to engage the control lever 31 to lock it in a desired position. In particular, the plate 41 can comprise a central track 43 defining a through opening crossed by the control lever 31: the control lever 31 is thus configured to move between the first position and the second position within such a track 43. The track 43 laterally comprises the teeth intended to engage the control lever 31.

The adjustment system 30 can comprise an elastic element 50 interposed between the cutting deck 20 and the shell 3 and configured to exert at least one elastic force F on the cutting deck 20. The elastic force F provided by the elastic element 50 is directed, at least in part, to the lifting in height of the cutting deck 20. In particular, the elastic force F is suitable for producing a partial compensation of the weight force of the cutting deck 20.

In particular, the elastic force F acts in a direction from the lowered position to the raised position of the cutting deck 20. In detail, the elastic force F is configured to contribute to the movement of the cutting deck 20 from the lowered position to the raised position.

The elastic force F is, at least during an operating condition of the device 2, opposite in direction with respect to a weight force of the cutting deck 20. In particular, the operating condition is defined at least when the device 2 rests on the land with the movement means 6 thereof, for example on the wheels or tracks thereof: in such an operating condition, the weight force of the cutting deck 20 is substantially orthogonal to the land 1 or to the support plane SP.

This elastic force F contributes to the lifting of the cutting deck 20, thereby assisting the operator in executing such an operation.

The elastic element 50 can comprise at least one among a traction spring, a compression spring, a torsion spring, or a pneumatic piston. The compression spring, the traction spring and the torsion spring can be spiral springs, of the type as shown in FIG. 4. The elastic element 50 can be made of metallic material, for example steel.

In the case of a torsion spring, the elastic element can be arranged at the fulcrum 33 of the control lever 31, or can be arranged at at least one among the first connector 35a of the first arm 35, the second connector 35b of the first arm 35, the first connector 36a of the second arm 36 and the second connector 36b of the second arm 36 of the adjustment system 30.

The adjustment system 30 is configured to vary a length, or an angular rotation in the case of a torsion spring, of the elastic element 50 during the movement of the cutting deck 20 between the lowered position and the raised position and vice versa. In other words, a movement of the cutting deck 20 and/or of the control lever 31 causes, through the kinematics of the adjustment system 30, a variation in length, or in angular rotation in the case of a torsion spring, of the elastic element 50. In particular, if the elastic element 50 comprises a traction spring, the transition from the lowered position to the raised position of the cutting deck 20 causes a reduction in length of the traction spring. On the contrary, if the elastic element 50 comprises a compression spring, the passage from the lowered position to the raised position of the cutting deck 20 determines an increase in length of the compression spring. The variation in length of the elastic element 50 in the passage from the raised position to the lowered position and vice versa can be comprised between 30 mm and 100 mm.

In any case, it should be noted that the elastic force F of the elastic element 50 decreases as the distance between the tool 4 and the land and/or the support plane SP increases: in particular the elastic force F of the elastic element 50 decreases during the transition from the lowered position to the raised position of the cutting deck 20. In other words, the adjustment system 30 is configured to load the elastic element 50 in the passage from the raised position to the lowered position. On the contrary, the adjustment system 30 is configured to unload the elastic element 50 in the passage from the lowered position to the raised position.

In energy terms, the elastic element 50 has a first elastic potential energy when the cutting deck 20 is placed in the lowered position, and a second elastic potential energy when the cutting deck 20 is placed in the raised position: the first elastic potential energy is greater than the second elastic potential energy. It should be noted that a difference between the first elastic potential energy and the second elastic potential energy defines a compensating drive energy: the compensating drive energy contributes at least in part to the movement of the cutting deck 20 from the lowered position to the raised position.

The traction spring of the elastic element 50 extends in length, when the cutting deck 20 is in the raised position, between 25 mm and 105 mm.

The traction spring of the elastic element 50 can have an elastic constant comprised between 0.6 N/m and 0.75 N/m.

The traction spring of the elastic element 50 can have an outer diameter comprised between 38 mm and 42 mm.

The traction spring of the elastic element 50 can have a number of turns comprised between 37 and 45.

The traction spring of the elastic element 50 can have a diameter of the helical wire comprised between 3.2 mm and 4 mm.

Alternatively, the torsion spring of the elastic element 50 can have an elastic constant comprised between 0.22 Nm/° and 0.26 Nm/°.

The elastic element 50, in the case of a traction or compression spring, extends in length between a first end 50a and a second end 50b. The first end 50a of the elastic element 50 is constrained to a pulling portion 61 of the shell 3, while the second end 50b is constrained to one among a pulling portion of the control lever 31, to the first arm 35 and/or to the second arm 36 of the adjustment system 30, to the cutting deck 20, to the first coupling 25 or to the second coupling 26 of the cutting deck 20, and to the drive lever 39 of the control lever 31.

The elastic element 50, for example the traction or compression spring, can extend in length transversely with respect to the support plane SP. For example, the elastic element 50 can define with the support plane SP an angle comprised between 45° and 80°, in particular between 55° and 70°. In greater detail the elastic element 50 can define with the longitudinal axis X an angle a comprised between 45° and 80°, in particular between 55° and 70°, as shown in FIG. 5.

The shell 3 comprises a base frame 10 placed in connection with the movement means 6 of the mobile device 2, as shown in FIG. 5. The base frame 10 can comprise one or more spars, preferably a left spar and a right spar, extending between the rear portion and the front portion of the mobile device 2. The base frame 10 can be made of metallic material, for example aluminium or steel.

The shell 3 can further comprise a pull bar 11 extending in length between a first portion 11a and a second portion 11b, in which the first portion 11a is constrained to the shell, for example to the base frame 10. The second portion 11b can be placed at a height greater than a height of the first portion 11a of the pull bar 11: in particular the pull bar 11 rises in height, optionally parallel to the vertical axis Z, starting from the base frame 10. The pull bar 11 can be transverse or orthogonal to the base frame 10, and extend away from the base frame 10.

The pull bar 11 can be constrained to the base frame 10 by welding or by a screw coupling: in fact, the pull bar 11 and the base frame 10 are integral with each other and define a single body. It should be noted that the second portion 11b is fixed with respect to the shell 3.

The second portion 11b of the pull bar 11 is constrained to the first end 50a of the elastic element 50: the second portion 11b of the pull bar 11 thus defines the pulling portion 61 of the shell 3 previously described in relation to the elastic element 50.

### ADVANTAGES

An advantage of the device of the present invention is that of physically assisting the operator during the lifting operations of the cutting deck. It should be noted that the cutting deck often has a high weight, typically between 60 kg and 70 kg. In this respect, the springs contribute to lifting the cutting deck, thereby reducing the effort required of the operator. Such an aspect is of considerable importance since the device of the present invention can be used by a great variety of subjects, for example professionals who carry out the operations of adjusting the height of the cutting deck several times during their working day.

Another advantage of this device is that of having, as a whole, a simple system employing a limited number of components with respect to the traditional solutions known in the art.

A further advantage of the present invention is being able to perform the operation while the user is seated in the driving station, without therefore the need to stop the tractor or to have to get off the tractor to adjust the height of the cutting deck.

The gripping portion of the control lever arranged in the central position further has the advantage of allowing a convenient lifting of the cutting deck for both “right-handed” and “left-handed” people. Such an architecture further allows the operator to lift the cutting deck using the right hand and the left hand together, thus redistributing the load between the right arm and the left arm.

1. A device for the maintenance of land, comprising:
a shell,
at least one tool configured to execute maintenance operations on said land,
at least one cutting deck carrying said tool and movable in height to vary a cutting height and
an adjustment system for adjusting the cutting deck in height with respect to the shell,
wherein said adjustment system comprises at least one elastic element interposed between the cutting deck and said shell and configured to exert at least one elastic force on said cutting deck said elastic force being suitable to produce a partial compensation of the weight force of the cutting deck and/or being directed, at least in part, to the lifting in height of the cutting deck,
wherein said adjustment system further comprises at least one control lever drivable by an operator and operatively connected to said cutting deck, said control lever being configured to move said cutting deck at least in height, and
wherein, considering a dimension in width of said device and/or of said shell at least one gripping portion of said control lever is located centrally with respect to said dimension in width.

2. The device according to claim 1, wherein the adjustment system is configured to move the cutting deck in height with respect to the land between:
a lowered position, in which a first distance is interposed between the tool and the land, and
a raised position, in which a second distance is interposed between the tool and the land, said second distance being greater than said first distance, wherein the elastic force decreases during a movement of the cutting deck from the lowered position to the raised position of the cutting deck and wherein said elastic element comprises a traction spring.

3-18. (canceled)

19. The device according to claim 1, wherein the shell comprises:
a base frame, and
a pull bar integral with the base frame and extending between a first portion and a second portion said first portion being constrained to the base frame and said second portion being constrained to an end of the elastic element, said pull bar extending in height from said base frame

20-24. (canceled)

25. The device according to claim 1, further comprising a driving station adapted to accommodate an operator intended to drive the device, wherein said at least one gripping portion of said control lever is arranged centrally in front of the driving station, wherein said control lever is arranged so that, during an operating condition of the device, the gripping portion of said control lever is graspable by the operator sitting in the driving station both with the right hand and with the left hand and wherein said gripping portion is shaped like a handle.

26-28. (canceled)

29. The device according to claim 1, wherein the control lever extends between said gripping portion and a fulcrum defining a hinge with the shell of the device, said fulcrum defining a rotation axis about which the control lever is movable by rotation, wherein the adjustment system comprises:
a return bar constrained and/or integral in rotation with the control lever and extending in length along the rotation axis of the fulcrum of the control lever, and
at least one drive lever constrained and/or integral in rotation with said return bar, such that said return bar is operatively interposed between the drive lever and the control lever, the drive lever extending in length between a first end, constrained to the return bar, and a second end directly or indirectly connected to the cutting deck, wherein said return bar defines said fulcrum, and wherein said drive lever is transverse or orthogonal to the return bar.

30-50. (canceled)

51. The device according to claim wherein the adjustment system comprises at least a first arm placed in connection between the cutting deck and the shell and a second arm placed in connection between the cutting deck and the shell, wherein the first arm connects the shell to a first coupling of the cutting deck and the second arm connects the shell to a second coupling of the cutting deck, which is distinct from the first coupling, wherein said first arm and said second arm are placed in connection between the cutting deck and the shell so as to form an articulated quadrilateral with the cutting deck and the shell.

52-56. (canceled)

57. The device according to claim 51, wherein the adjustment system comprises a connecting rod between operatively interposed between the cutting deck and the control lever, so as to transmit to the cutting deck a displacement imposed on the control lever and wherein the connecting rod is placed in connection between an end of the drive lever and a third coupling of the cutting deck.

58-70. (canceled)

71. A device for the maintenance of land, comprising:
a shell,
at least one tool configured to execute maintenance operations on said land,
at least one cutting deck carrying said tool and movable in height to vary a cutting height,
an adjustment system for adjusting the cutting deck in height with respect to the shell,
at least one control lever drivable by an operator and operatively connected to said cutting deck and
a driving station adapted to accommodate an operator intended to drive the device,
wherein said adjustment system comprises at least one elastic element interposed between the cutting deck and said shell and configured to exert at least one elastic force on said cutting deck,
wherein said control lever is configured to move said cutting deck at least in height,
wherein said control lever is movable between a first position defining the lowered position of the cutting deck a second position defining the raised position of the cutting deck,
wherein said control lever includes intermediate positions interposed between said first position and said second position, each of said intermediate positions of the control lever defining a respective intermediate position of the cutting deck interposed between said lowered position and said raised position, and
wherein said control lever is movable towards and away from the driving station.

72-190. (canceled)

191. A device for the maintenance of land, comprising:
a shell,
at least one tool configured to execute maintenance operations on said land,
at least one cutting deck carrying said tool and movable in height to vary a cutting height, and
an adjustment system for adjusting the cutting deck in height with respect to the shell.

192. The device according to claim 191, wherein said adjustment system comprises at least one elastic element interposed between the cutting deck and said shell and configured to exert at least one elastic force on said cutting deck, wherein said elastic force is suitable for producing a partial compensation of the weight force of the cutting deck, wherein said elastic force is directed, at least in part, to the lifting in height of the cutting deck, wherein said adjustment system comprises at least one control lever drivable by an operator and operatively connected to said cutting deck, said control lever being configured to move said cutting deck at least in height, and wherein, considering a dimension in width of said shell, at least one gripping portion of said control lever is located centrally with respect to said dimension in width.

193-197. (canceled)

198. The device according to claim 191, wherein said device for the maintenance of land grass is a manually-driven lawnmower tractor, wherein said device comprises movement means carried by said shell and configured to allow or cause a movement of the device on said land, said movement means defining a support plane of the device.

199-219. (canceled)

220. The device according to claim 192, wherein said elastic force of the elastic element decreases with increasing distance between the tool and the land, wherein said elastic force of the elastic element decreases with increasing distance between the tool and the support plane, wherein the elastic force of the elastic element decreases during the passage from the lowered position to the raised position of the cutting deck.

221-229. (canceled)

230. The device according to claim 192, wherein the control lever is movable between:
a first position defining the lowered position of the cutting deck,
a second position defining the raised position of the cutting deck, and
intermediate positions interposed between said first position and said second position, each of said intermediate positions of the control lever defining a respective intermediate position of the cutting deck interposed between said lowered position and said raised position,
wherein the adjustment system comprises a locking system configured to achieve a stable stationing of the cutting deck in a position in height pre-selected by the operator, said position in height selectively comprising the raised position, the lowered position and one or more intermediate positions between said lowered position and said raised position, and
wherein the gripping portion of said control lever is associated with a button configured to allow the operator to establish a temporary disabling of said locking system so as to operate a variation of the height of said cutting deck by means of a switching of the position of said control lever.

231-251. (canceled)

252. The device according to claim 192, wherein the control lever extends between a gripping portion configured to be gripped by an operator, and a fulcrum defining a hinge with the shell of the device, wherein said fulcrum defines a rotation axis about which the control lever is movable by rotation, and wherein the adjustment system comprises a return bar integral in rotation with the control lever and extending in length along the rotation axis of the fulcrum of the control lever.

253-273. (canceled)

274. The device according to claim 252, wherein the adjustment system further comprises a drive lever constrained to said return bar such that said return bar is operatively interposed between the drive lever and the control lever and wherein the drive lever extends in length between a first end, constrained to the return bar, and a second end connected directly or indirectly to the cutting deck.

275-277. (canceled)

278. The device according to claim 198, wherein the shell comprises:
a base frame placed in connection with the movement means of the mobile device and
a pull bar extending in length between a first portion and a second portion, said first portion being constrained to the base frame and said second portion being constrained to one end of the elastic element, said pull bar extending in height from said base frame.

279-281. (canceled)

282. The device according to claim 192, wherein the elastic element extends in length transversely with respect to the support plane and wherein the elastic element defines with the support plane (SP) an angle comprised between 45° and 80°.

283-292. (canceled)

293. The device according to claim 191, wherein the adjustment system comprises:
the cutting deck having a first coupling and a second coupling spaced apart from each other,
a portion of the shell comprising a first support and a second support spaced apart from each other,
a first oscillating arm placed in connection between the cutting deck and the shell, and
a second oscillating arm placed in connection between the cutting deck and the shell,
wherein the first arm extends between:
a first connector constrained to the first support of the shell, and
a second connector constrained to the first coupling of the cutting deck;
wherein the second arm extends between:
a first connector constrained to the second support of the shell, and
a second connector constrained to the second coupling of the cutting deck, and
wherein the distance between the first coupling and a second coupling of the cutting deck is substantially equal to the distance between the first support and the second support of the shell.

294-299. (canceled)

300. The device according to claim 293, wherein the adjustment system comprises a connecting rod placed in connection between the cutting deck and the control lever, and wherein the connecting rod is placed in connection between the second coupling of the cutting deck and the second end of the drive lever of the control lever.

301-315. (canceled)

316. The device according to claim 192, wherein the elastic element comprises a traction spring defining an elastic constant comprised between 0.6 N/m and 0.75 N/m.

317. The device according to claim 316, wherein the traction spring of the elastic element has an outer diameter comprised between 38 mm and 42 mm.

318-323. (canceled)
